(19) United States
(12) Patent Application Publication
(10) Pub. No.: US 2021/0285531 A1
(43) Pub. Date: Sep. 16, 2021

(54) GEAR MECHANISM, AND MOTOR AND ELECTRICAL APPLIANCE INCLUDING GEAR MECHANISM

(71) Applicant: Nidec Corporation, Kyoto (JP)

(72) Inventors: Mingwen ZHAO, Kyoto (JP); Shamsol Bin CHE SAKRI, Kyoto (JP); Guangyao XIE, Kyoto (JP)

(21) Appl. No.: 16/330,422

(22) PCT Filed: Sep. 6, 2017
(86) PCT No.: PCT/JP2017/032161

§ 371 Date: Mar. 5, 2019

(30) Foreign Application Priority Data
Sep. 6, 2016 (CN) 201610804020.3

(51) Int. Cl. F16H 55/17; F16H 55/06; H02K 7/116

(52) U.S. Cl. CPC F16H 55/17; H02K 7/116; F16H 55/06

(57) ABSTRACT

A gear mechanism includes a gear shaft rotatable about a central axis extending in a vertical direction, a gear perpendicular to the gear shaft and extending radially outward, and a gear bearing on an outer circumferential surface of the gear shaft to rotatably support the gear. The gear includes a contact surface to be in contact with a lower end surface of the gear bearing, and a recessed housing portion recessed in a downward direction relative to the contact surface. Thus, a lubricating fluid pushed out onto a lower surface of the bearing is contained in the housing portion to prevent the lubricating fluid from being pushed out to a position outside of an outer circumferential surface of the bearing when the bearing is press fitted to a surface of the gear.

### BACKGROUND OF THE INVENTION

### 1. Field of the Invention

The present disclosure relates to a gear mechanism. In particular, the present disclosure relates to a gear mechanism, a motor including the gear mechanism, and an electrical appliance including the gear mechanism.

### 2. Description of the Related Art

In related art, gear mechanisms are connected to motors, various types of electrical appliances, and so on. Such a gear mechanism includes a gear shaft arranged to rotate a gear, and a gear bearing arranged to support the gear. A lubricating fluid (e.g., grease, etc.) can be applied to a gap between the gear shaft and the gear bearing to prevent the gear mechanism from overheating due to friction between the gear shaft and the gear bearing. The gear shaft and the gear bearing are arranged to rotate relative to each other through the lubricating fluid.

In order to realize the above gear structure, an operation of applying the lubricating fluid to an outer circumferential surface of the gear shaft and then press fitting the gear bearing to the gear along a direction in which the gear shaft extends, for example, is required. It will be understood that the above-described related-art techniques are described for easier understanding by a person skilled in the art, merely to clearly explain the environment of example embodiments of the present invention. The description of these techniques in the BACKGROUND ART section of the present application should not be regarded as grounds for example embodiments of the present invention being known to a person skilled in the art.

In the case of the related-art gear structure, however, each of the outer circumferential surface of the gear shaft and an inner circumferential surface of the gear bearing is typically circular when viewed in the direction in which the gear shaft extends. Accordingly, after the gear bearing has been attached to the gear shaft, the gap between the gear shaft and the gear bearing is very narrow, the lubricating fluid exists in the gap, and an end surface of the gear bearing which faces the gear after the gear bearing has been attached to the gear shaft is in contact with a surface of the gear over 360 degrees in a circumferential direction. Therefore, a gap between the gear bearing and the gear is also very narrow.

Accordingly, because of the narrow gap between the gear shaft and the bearing, the lubricating fluid is pushed out onto the end surface of the gear bearing which faces the gear in a process of attaching the gear bearing to the gear shaft with the lubricating fluid applied thereto. Moreover, when the gear bearing is brought into contact with the gear by the press fitting, a large portion of the lubricating fluid pushed out onto the aforementioned end surface of the gear bearing is further pushed out radially outwardly of the bearing, and is pushed out to a position outside of an outer circumferential surface of the gear bearing. Therefore, a large portion of the lubricating fluid is not held between the gear shaft and the gear bearing. As a result, lubrication between the gear shaft and the gear bearing may not be easily achieved.

### SUMMARY OF THE INVENTION

According to a first example embodiment of the present disclosure, a gear mechanism includes a gear shaft rotatable about a central axis extending in a vertical direction, a gear perpendicular to the gear shaft and extending radially outward, and a gear bearing on an outer circumferential surface of the gear shaft to rotatably support the gear. The gear includes a contact surface to be in contact with a lower end surface of the gear bearing and a recessed housing portion recessed in a downward direction relative to the contact surface.

According to a second example embodiment of the present invention, a motor includes the gear mechanism described in the preceding paragraph.

According to a third example embodiment of the present invention, an electrical appliance includes the gear mechanism described above.

In the gear mechanism, the gear includes the recessed housing portion recessed in the downward direction relative to the contact surface in contact with the bearing. Thus, when the bearing has been press fitted to a surface of the gear, a lubricating fluid pushed out onto an end surface of the bearing is able to be contained in the recessed housing portion. Therefore, the lubricating fluid is never pushed out to a position outside of an outer circumferential surface of the bearing. In addition, when the gear is rotated, the housed lubricating fluid is able to easily flow into a gap between the gear shaft and the gear bearing. Accordingly, a lubricating effect is able to be achieved in the gear mechanism. As a result, reduced friction between the gear shaft and the gear bearing is able to be achieved to prevent the gear mechanism from overheating.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a schematic diagram illustrating a structure of a gear mechanism according to a first example embodiment of the present disclosure.

FIG. 2 is a sectional view of the gear mechanism according to the first example embodiment of the present disclosure taken along an axial direction.

FIG. 3 is a schematic diagram illustrating one structure of a gear and a gear shaft of the gear mechanism according to the first example embodiment of the present disclosure.

FIG. 4 is an enlarged view of a portion of FIG. 3.

FIG. 5 is a sectional view of the gear shaft and a gear bearing of the gear mechanism according to the first example embodiment of the present disclosure taken along line X-X in FIG. 2.

FIG. 6 is a schematic diagram illustrating another structure of the gear and the gear shaft of the gear mechanism according to the first example embodiment of the present disclosure.

FIG. 7 is a schematic diagram illustrating yet another structure of the gear and the gear shaft of the gear mechanism according to the first example embodiment of the present disclosure.

FIG. 8 is a schematic diagram illustrating a structure of a motor according to a second example embodiment of the present disclosure.

### DETAILED DESCRIPTION OF THE PREFERRED EMBODIMENTS

Hereinafter, example embodiments of the present invention will be described in detail with reference to the accompanying drawings.

It will be understood that the scope of embodiments of the present invention is not limited to the scope of disclosures made in the specification, drawings, and so on of the present application. It should be understood that the embodiments of the present invention include variations, modifications, and equivalents thereof within the scope of the appended claims.

Features described and/or illustrated with respect to one embodiment may be applied in one or more other embodiments in the same or a similar manner, and may be combined with features of other embodiments or replace features of other embodiments.

Note that the wordings “include”, “contain”, “have”, and the like as used herein indicate that a feature, a whole member, or an assembly exists, but do not eliminate the possibility that one or more other features, whole members, or assemblies will exist or be added.

The aforementioned and other features, elements, means, effects, and characteristics related to the present invention will be better understood from the following detailed descriptions of preferred embodiments of the present invention, taken in conjunction with the accompanying drawings.

In the following description of the present invention, a direction parallel to a direction in which a gear shaft extends is referred to as a “gear axis direction” for the sake of convenience. Radial directions centered on the gear shaft are each referred to by the term “radial direction”, “radial”, or “radially”. A circumferential direction about the gear shaft is referred to by the term “circumferential direction”, “circumferential”, or “circumferentially”. Note that a direction along the gear shaft is referred to as a “vertical direction”. In addition, in the vertical direction, a direction from a gear toward a gear bearing is an “upward direction”, while a direction opposite to the “upward direction” is a “downward direction”. It is necessary to mention that the above definition of the upward direction and the downward direction is simply made for the sake of convenience in description, and is not meant to restrict in any way the orientation of a motor at the time of mounting or manufacture or when in use.

Hereinafter, gear mechanisms, a motor, and an electrical appliance according to preferred embodiments of the present invention will be described with reference to the accompanying drawings.

### First Embodiment

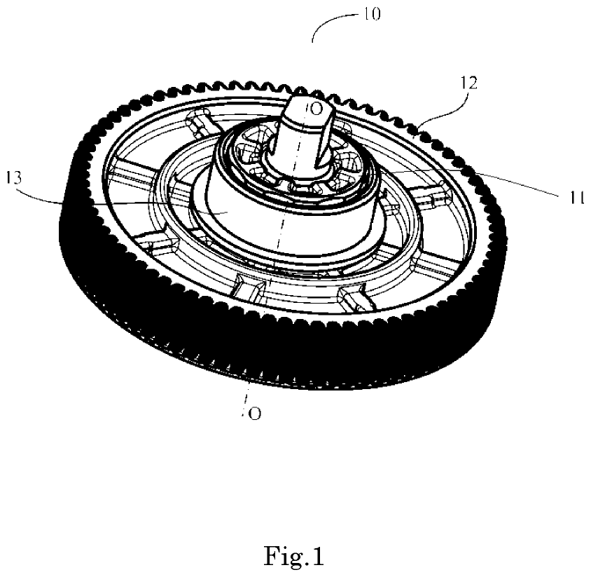

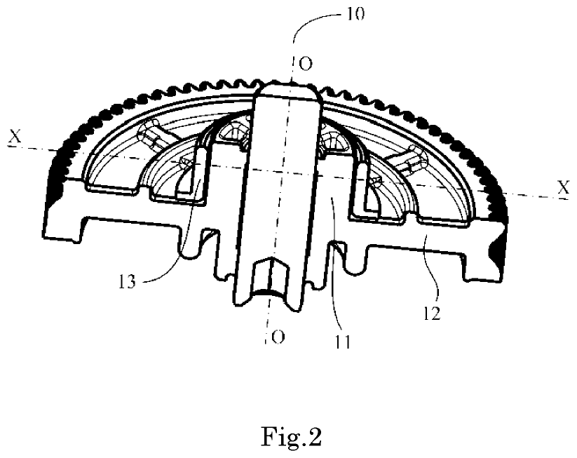

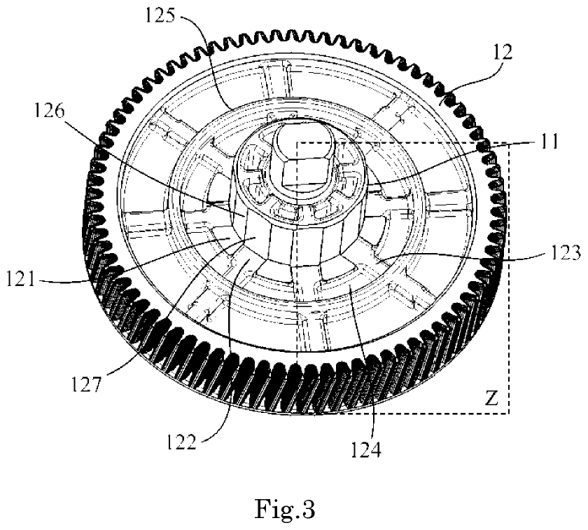

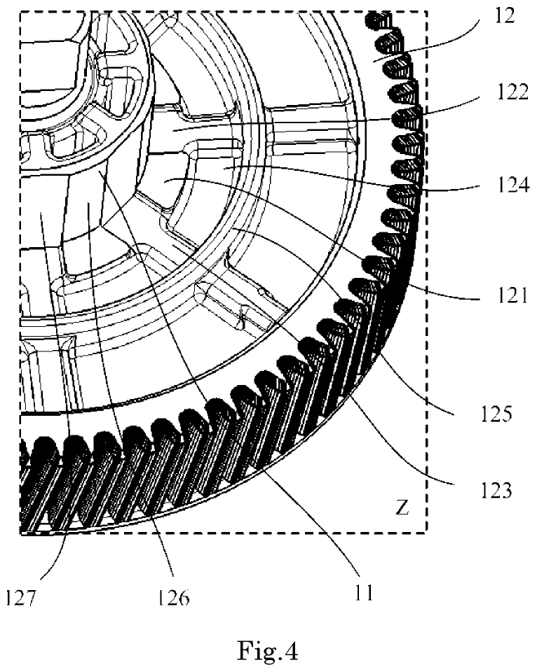

FIG. 1 is a schematic diagram illustrating the structure of a gear mechanism 10. FIG. 2 is a sectional view of the gear mechanism according to a first embodiment taken along an axial direction. FIG. 3 is a schematic diagram illustrating one structure of a gear and a gear shaft of the gear mechanism 10 without a gear bearing being attached thereto to clearly illustrate the internal structure of the gear mechanism 10. FIG. 4 is a schematic diagram illustrating the structure of an area within a dotted-line frame Z in FIG. 3 in an enlarged form.

Referring to FIGS. 1 to 4, the gear mechanism 10 includes a gear shaft 11 arranged to rotate about a central axis O-O extending in the vertical direction, a gear 12 perpendicular to the gear shaft 11 and arranged to extend radially outward, and a gear bearing 13 arranged on an outer circumferential surface of the gear shaft 11 and arranged to rotatably support the gear 12. The gear shaft is a substantially tubular portion. A rotating shaft is arranged to pass through the gear shaft 11. An outer circumferential surface of an end of the rotating shaft on one axial side includes a pair of arc-shaped surfaces radially opposite to each other, and a pair of flat portions radially opposite to each other. An end portion of the rotating shaft on the one axial side is arranged to project axially upward relative to an end surface of the gear bearing 13 on the one axial side. An outer circumference of the end of the rotating shaft on the one axial side is arranged radially inward of an outer circumference of a portion of the rotating shaft to which the gear bearing 13 is attached. In other words, a shoulder is defined between the end of the rotating shaft on the one axial side and the portion of the rotating shaft to which the gear bearing 13 is attached. The gear bearing 13 is attached to the outer circumferential surface of the gear shaft 11 through, for example, press fitting. The gear 12 is substantially circular when viewed in the axial direction. The gear 12 is arranged to extend radially outward from the gear shaft 11, which is arranged to extend along the central axis O-O. The gear 12 includes a wall portion extending in the axial direction at a radially outer end portion thereof. A plurality of teeth are defined in an outer circumferential surface of the wall portion. In the present embodiment, the gear 12 is defined integrally with the gear shaft 11. Note that the gear 12 and the gear shaft 11 may alternatively be defined by separate members.

Referring to FIGS. 3 and 4, the gear 12 includes contact surfaces 121 each of which is arranged to be in contact with a lower end surface of the gear bearing 13, and a recessed housing portion 122 recessed in the downward direction relative to the contact surfaces 121. A lubricating fluid (e.g., a grease, etc.) is applied to a gap between the gear shaft 11 and the gear bearing 13. Accordingly, when the gear bearing 13 is attached to a surface of the gear 12 through press fitting, at least a portion of the lubricating fluid in the gap between the gear shaft 11 and the gear bearing 13 is pushed out onto a lower surface of the gear bearing 13, and is housed in the recessed housing portion 122. This contributes to preventing the lubricating fluid from being pushed out and spreading outwardly of an outer circumferential surface of the gear bearing 13. When the gear shaft 11 is driven to rotate the gear 12, the lubricating fluid housed in the recessed housing portion 122 can flow into the gap between the gear shaft 11 and the gear bearing 13. Accordingly, lubrication is achieved between the members of the gear mechanism 10, so that friction between the gear shaft 11 and the gear bearing 13 can be reduced to enable smooth rotation of each of the gear shaft 11, the gear bearing 13, and the gear 12. This contributes to preventing the gear mechanism 10 from overheating. Note that the lubricating fluid is not limited to the grease, but may alternatively be any desired lubricant. The lubricating fluid is preferably a lubricant in a semi-fluid, semi-solid, or solid state. It is desirable that the lubricating fluid is a non-Newtonian fluid rather than a Newtonian fluid in the present embodiment.

In the present embodiment, the number of contact surfaces 121 is not limited to particular values, but may be set in any desired manner. The number of contact surfaces 121 may be one, or more than one. For example, the contact surface 121 may be a contact surface arranged in an annular shape to extend 360 degrees in a circumferential direction. In this case, a recessed housing portion arranged to extend in an annular shape to extend 360 degrees in the circumferential direction is arranged inside of (that is, radially inside of) an inner circumference of the annular contact surface 121. Note that a plurality of recessed housing portions in an annular shape may be defined radially inside of the annular contact surface 121.

In the case where a plurality of contact surfaces 121 are provided, the recessed housing portion 122 may include “spaced recessed housing portions” arranged to alternate with the contact surfaces 121 in the circumferential direction. In other words, the contact surfaces 121 and the spaced recessed housing portions are arranged alternately in the circumferential direction. In this case, when the gear bearing 13 is attached to the gear shaft 11 through press fitting, the lubricating fluid pushed out onto the lower surface of the gear bearing 13 can be housed in the spaced recessed housing portions. Because the spaced recessed housing portions are arranged to alternate with the contact surfaces 121, portions of the lubricating fluid can be housed at a plurality of different circumferential positions on an upper surface of the gear 12. This makes it easier for the housed lubricating fluid to flow into a gap between each contact surface 121 and the gear bearing 13 when the gear 12 rotates, enabling the lubricating fluid to spread more evenly between the contact surfaces 121 and the gear bearing 13. As a result, each of the gear shaft 11, the gear 12, and the gear bearing 13 is able to more smoothly rotate. This contributes to preventing the gear mechanism 10 from overheating. In the structure illustrated in FIG. 3, each of the contact surfaces 121 is connected to the gear shaft 11, while the spaced recessed housing portions, which are arranged alternately, are not connected to one another. Note, however, that the recessed housing portion 122 may not have the above-described structure, but may alternatively have another structure including the spaced recessed housing portions. For example, the recessed housing portion 122 may include an annular recessed portion which is substantially annular and is centered on the gear shaft 11. This annular recessed portion is recessed in the downward direction relative to the contact surfaces 121. In this case, the contact surfaces 121 are not connected to the gear shaft 11. The annular recessed portion is defined radially between the contact surfaces 121 and the gear shaft 11, and the spaced recessed housing portions are arranged to be in communication with one another through the annular recessed portion. In other words, the annular recessed portion is arranged radially outside of the outer circumferential surface of the gear shaft 11. The contact surfaces 121 and the spaced recessed housing portions are arranged radially outside of the annular recessed portion. The contact surfaces 121 and the spaced recessed housing portions are arranged alternately in the circumferential direction. The spaced recessed housing portions are arranged to be in communication with the annular recessed portion.

Referring to FIGS. 3 and 4, the gear 12 may further include extending housing grooves 123 arranged to extend further radially outward from a radially outer side of the recessed housing portion 122, and expanding recessed portions 124 arranged on both circumferential sides of each extending housing groove 123, and recessed in the downward direction relative to the contact surfaces 121. The extending housing grooves 123 are arranged to extend substantially in a radial manner on the surface of the gear 12 when viewed along the central axis O-O. The extending housing grooves 123 are arranged to be in communication with the recessed housing portion 122. The extending housing grooves 123 are arranged at regular intervals in the circumferential direction. The extending housing grooves 123 are preferably arranged to extend up to the wall portion of the gear 12, the wall portion being cylindrical and having the teeth. The expanding recessed portions 124 are arranged radially outside of the contact surfaces 121. The circumferential width of each expanding recessed portion 124 is greater than the circumferential width of each contact surface 121. The circumferential width of each recessed housing portion 122 is greater than the circumferential width of each extending housing groove 123. A passage for the lubricating fluid is expanded by the extending housing grooves 123 and the expanding recessed portions 124. That is, a housing space in which the lubricating fluid is housed is defined by the recessed housing portion 122, the extending housing grooves 123, and the expanding recessed portions 124. Thus, an increased amount of the lubricating fluid can be held in the recessed housing portion 122, the extending housing grooves 123, and the expanding recessed portions 124, and a flow of the lubricating fluid in the gap between the gear bearing 13 and the gear shaft 11 is facilitated to enable smoother rotation of the gear shaft 11, the gear bearing 13, and the gear 12, which together define the gear mechanism 10, through lubrication by the lubricating fluid.

The gear 12 may further include a stopper portion 125 arranged to cover the expanding recessed portions 124 and the extending housing grooves 123 on the radially outer side, and arranged to project in the upward direction. The stopper portion 125 is substantially annular when viewed along the central axis O-O. The stopper portion 125 is arranged radially outside of the expanding recessed portions. The stopper portion 125 defines a portion of an inner wall defining each expanding recessed portion 124. Each extending housing groove 123 is connected to the stopper portion 125. In more detail, each extending housing groove 123 is arranged to extend from the recessed housing portion 122 to the stopper portion 125. In this case, the lubricating fluid can be retained inside of the stopper portion 125, and the lubricating fluid can be prevented from intruding into a position radially outside of the stopper portion 125. In addition, provision of the stopper portion 125 in the gear 12 leads to improved rigidity of the gear 12. Each extending housing groove 123 may be arranged to extend further radially outward from the stopper portion 125.

Referring to FIGS. 3 and 4, the gear shaft 11 may include contact portions 126 each of which is arranged to be in contact with the gear bearing 13, and non-contact portions 127 each of which is arranged to be out of contact with the gear bearing 13. In other words, the outer circumferential surface of the gear shaft 11 may include the contact portions 126 each of which is arranged to be in contact with the gear bearing 13, and the non-contact portions 127 each of which is arranged to be out of contact with the gear bearing 13. The contact portions 126 and the non-contact portions 127 are preferably arranged alternately in the circumferential direction.

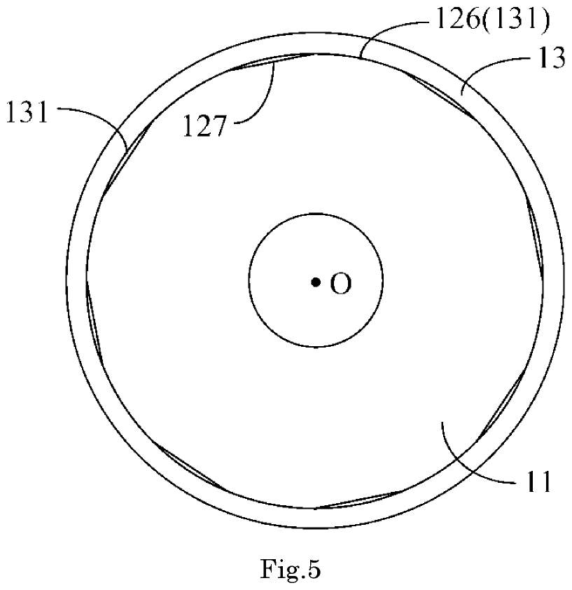

FIG. 5 is a sectional view of the gear shaft 11 and the gear bearing 13 taken along line X-X in FIG. 2. Referring to FIG. 5, an inner surface 131 of the gear bearing 13 is substantially circular. Referring to FIGS. 3 to 5, each non-contact portion 127 is a flat surface extending in the axial direction. The non-contact portion 127 assumes a substantially straight line when viewed in the axial direction. When the gear bearing 13 is attached to the gear shaft 11, each contact portion 126 of the gear shaft 11 is brought into contact with the inner surface 131 of the gear bearing 13. A gap is defined between each non-contact portion 127 of the gear shaft 11 and the inner surface 131 of the gear bearing 13. In other words, each non-contact portion 127 of the gear shaft 11 will be opposed to the inner surface 131 of the gear bearing 13 with a gap therebetween.

Thus, when the gear shaft 11 and the gear bearing 13 have been attached to each other through press fitting, the lubricating fluid applied to the gear shaft 11 and so on can easily flow into the gap defined between each non-contact portion 127 and the gear bearing 13, so that the lubricating fluid spreads between the gear shaft 11 and the gear bearing 13.

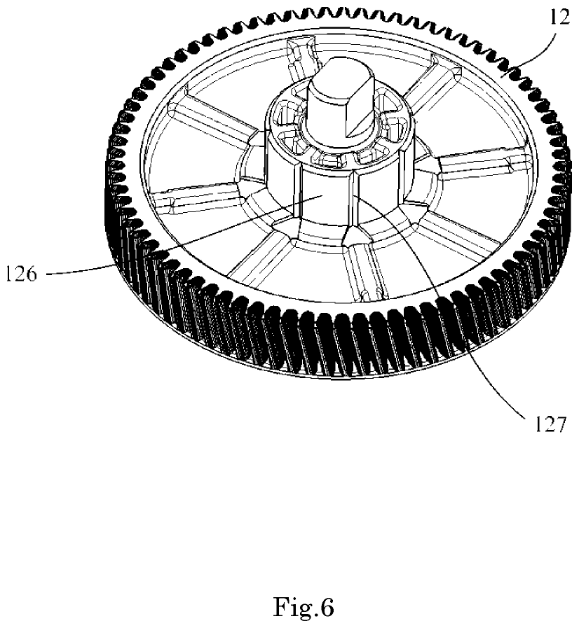

Note that the non-contact portions 127 may alternatively be in any other desired form as long as they are recessed radially inward relative to the contact portions 126. For example, although each of the non-contact portions 127 illustrated in FIGS. 1 to 5 is a flat surface extending up to the gear 12 along the vertical direction and defined in the outer circumferential surface of the gear shaft 11, this is not essential to the present invention. FIG. 6 illustrates another form of the non-contact portions 127. As illustrated in FIG. 6, each non-contact portion 127 may be a groove recessed radially inward relative to the contact portions 126, and arranged to extend up to the gear 12 along the vertical direction.

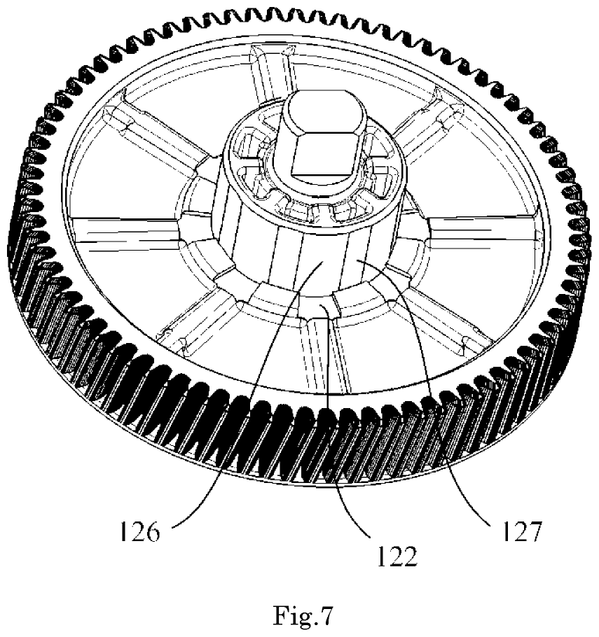

The positional relationship of the recessed housing portion 122 with the contact portions 126 and the non-contact portions 127 may be arbitrarily set in accordance with the structure of a device. For example, the recessed housing portion 122 is connected to each non-contact portion 127 in FIGS. 3 and 4. Note, however, that the structure of the recessed housing portion 122 is not limited to this example. For example, the recessed housing portion 122 may alternatively be connected to each contact portion 126 as illustrated in FIG. 7. A passage in which the lubricating fluid can be housed can be defined by the non-contact portions 127 and the recessed housing portion 122. In the case where the lubricating fluid has been housed in the recessed housing portion 122, when the gear shaft 11 is driven to rotate the gear 12, the lubricating fluid can flow into the gap between the gear shaft 11 and the gear bearing 13, so that a lubricating effect can be obtained between the gear shaft 11 and the gear bearing 13. When the recessed housing portion 122 is connected to each non-contact portion 127, the passage for the lubricating fluid can be easily defined to obtain a better lubricating effect in the gear mechanism 10.

As illustrated in FIGS. 3 and 4, the recessed housing portion 122 may be connected to the gear shaft 11. Accordingly, when the gear shaft 11 is driven to rotate the gear 12, the lubricating fluid can easily flow from the recessed housing portion 122 into the gap between the gear shaft 11 and the gear bearing 13. Note, however, that the recessed housing portion 122 may not necessarily be connected to the gear shaft 11. For example, the recessed housing portion 122 and the gear shaft 11 may alternatively be separated from each other by the contact surfaces 121.

Each of the gear shaft 11 and the gear bearing 13 may be made of any desired material.

For example, the gear shaft 11 may be made of a resin material. The gear bearing 13 may be made of a metal material. This leads to a reduced production cost of the gear mechanism 10. In addition, when the gear shaft 11 is driven to rotate the gear 12, heat is generated in the gear shaft 11 and the gear 12 by friction. As mentioned above, the gear shaft 11 is arranged radially inward of the gear bearing 13. In other words, the gear bearing 13 is arranged radially outward of the gear shaft 11. The resin material (i.e., the gear shaft 11) arranged radially inside has a coefficient of thermal expansion higher than that of the metal material (i.e., the gear bearing 13) arranged radially outside. Accordingly, with heat being generated by friction, each of the resin material (i.e., the gear shaft 11) and the metal material (i.e., the gear bearing 13) expands due to the heat, and a difference therebetween in the coefficient of thermal expansion causes a further reduced width of the gap between the gear shaft and the gear bearing 13. Accordingly, when compared to conventional gear mechanisms, the gear mechanism 10 according to an embodiment of the present invention is able to achieve a greatly improved lubricating effect in the gear mechanism 10 due to provision of the recessed housing portion 122 in which the lubricating fluid is housed.

As described above, in the gear mechanism 10, the lubricating fluid pushed out onto the lower surface of the gear bearing 13 can be housed in the recessed housing portion. Accordingly, even when the gear bearing 13 has been press fitted onto the surface of the gear 12, the lubricating fluid is never pushed out to a position outside of the outer circumferential surface of the gear bearing 13. As a result, when the gear shaft 11 is driven to rotate the gear 12, the housed lubricating fluid can easily flow into the gap between the gear shaft 11 and the gear bearing 13. Accordingly, an improved lubricating effect can be achieved in the gear mechanism 10 to achieve reduced friction between the gear shaft 11 and the gear bearing 13. This contributes to preventing the gear mechanism 10 from overheating.

### Second Embodiment

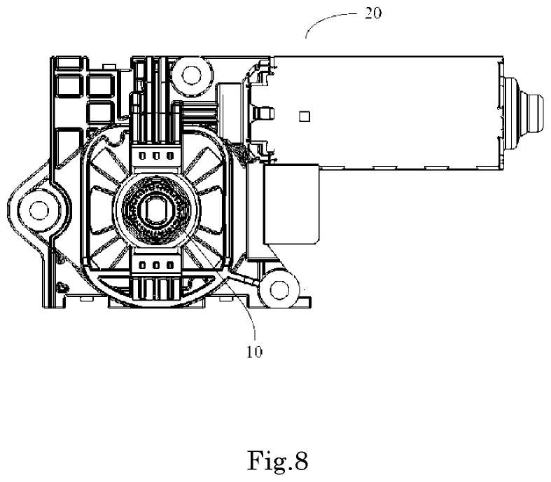

FIG. 8 is a schematic diagram illustrating the structure of a motor 20. Referring to FIG. 8, the motor 20 includes a gear mechanism 10. The gear mechanism 10 of the motor 20 is the same as the gear mechanism 10 described above, and, therefore, is not described here to avoid redundancy.

The motor 20 according to a second embodiment includes the gear mechanism 10 described above, and is therefore able to house the lubricating fluid pushed out onto the lower surface of the gear bearing. Accordingly, even when the gear bearing has been press fitted onto the surface of the gear, the lubricating fluid is never pushed out to a position outside of the outer circumferential surface of the gear bearing, and when the gear shaft is driven to rotate the gear, the housed lubricating fluid can easily flow into the gap between the gear shaft and the gear bearing. Accordingly, a lubricating effect can be ensured to achieve reduced friction and prevent the gear mechanism 10 from overheating. Moreover, the motor 20 can be prevented from overheating due to heat transferred from the gear mechanism 10 to the motor 20.

### Third Embodiment

A third embodiment relates to an electrical appliance. The electrical appliance includes a gear mechanism 10. The gear mechanism 10 of the electrical appliance is the same as the gear mechanism 10 described above, and, therefore, is not described here to avoid redundancy.

The electrical appliance according to the third embodiment includes the gear mechanism 10 described above, and is therefore able to house the lubricating fluid pushed out onto the lower surface of the gear bearing. Accordingly, even when the gear bearing has been press fitted onto the surface of the gear, the lubricating fluid is never pushed out to a position outside of the outer circumferential surface of the gear bearing, and when the gear shaft is driven to rotate the gear, the housed lubricating fluid can easily flow into the gap between the gear shaft and the gear bearing. Accordingly, an improved lubricating effect can be achieved in the gear mechanism 10. As a result, reduced friction between the gear shaft and the gear bearing can be achieved to prevent the gear mechanism 10 from overheating. Moreover, the electrical appliance including the gear mechanism 10 can be prevented from overheating.

In the present embodiment, the electrical appliance may be any electrical appliance that uses a gear mechanism. The electrical appliance may be, for example, a mechanism used for a sunroof attached to a body of a vehicle. Note, however, that the gear mechanism 10 may alternatively be used as a gear mechanism of another electrical appliance. The gear mechanism described above may be used as, for example, a gear mechanism of a household electrical appliance, such as an indoor unit of an air conditioner, an outdoor unit of an air conditioner, a water dispenser, a washing machine, a vacuum cleaner, a compressor, a blower, a blender, or the like, or may be used as a gear mechanism of various types of information appliances, industrial equipment, or the like.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-12. (canceled)

13. A gear mechanism comprising:
a gear shaft rotatable about a central axis extending in a vertical direction;
a gear perpendicular to the gear shaft and extending radially outward; and
a gear bearing on an outer circumferential surface of the gear shaft to rotatably support the gear; the gear includes:
a contact surface to be in contact with a lower end surface of the gear bearing; and
a recessed housing portion recessed in a downward direction relative to the contact surface.

14. The gear mechanism according to claim 13, wherein
a plurality of the contact surfaces are provided; and
the recessed housing portion includes spaced recessed housing portions alternating with the contact surfaces in a circumferential direction.

15. The gear mechanism according to claim 14, wherein the gear includes:
an extending housing groove extending farther radially outward from a radially outer side of the recessed housing portion; and
expanding recessed portions on both circumferential sides of the extending housing groove and recessed in the downward direction relative to the contact surfaces.

16. The gear mechanism according to claim 15, wherein the gear includes a stopper to cover the expanding recessed portions and the extending housing groove on a radially outer side and projecting in an upward direction.

17. The gear mechanism according to claim 13, wherein the gear shaft includes a contact portion to be in contact with the gear bearing, and a non-contact portion to be out of contact with the gear bearing.

18. The gear mechanism according to claim 17, wherein the non-contact portion is a flat portion defined in the outer circumferential surface of the gear shaft and extending up to the gear along the vertical direction.

19. The gear mechanism according to claim 17, wherein the non-contact portion includes a groove portion recessed radially inward relative to the contact portion and extending up to the gear along the vertical direction.

20. The gear mechanism according to claim 17, wherein the recessed housing portion is connected to the non-contact portion.

21. The gear mechanism according to claim 13, wherein the recessed housing portion is connected to the gear shaft.

22. The gear mechanism according to claim 13, wherein
the gear shaft is made of a resin; and
the gear bearing is made of a metal.

23. A motor mechanism comprising the gear mechanism of claim 13.

24. An electrical appliance comprising the gear mechanism of claim 13.
